(19) United States
(12) Patent Application Publication
(10) Pub. No.: US 2008/0049345 A1
(43) Pub. Date: Feb. 28, 2008

(54) Color wheel unit

(75) Inventor: Shinichi Niwa, Kitasaku-gun (JP)

Correspondence Address: OLIFF & BERRIDGE, PLC, P.O. BOX 320850, ALEXANDRIA, VA, 22320-4850, US

(73) Assignee: MINEBEA CO., LTD., KITASAKU-GUN (JP)

(21) Appl. No.: 11/878,299

(22) Filed: Jul. 23, 2007

(30) Foreign Application Priority Data
Aug. 28, 2006 (JP) 2006-230359

(51) Int. Cl. G02B 5/22

(52) U.S. Cl. 359/889

(57) ABSTRACT

A color wheel unit includes: a color wheel including a plurality of color regions; a motor adapted to rotate the color wheel and including a rotor with a rotary shaft; and a case adapted to house the color wheel and the motor and including a heat radiating means disposed at the outer surface of the case. In the color wheel unit, a first protrusion structure extending radially outwardly is disposed at the outer circumferential surface of the rotor, and a second protrusion structure extending radially inwardly is disposed at the inner surface of the case, wherein the projection area of the second protrusion structure on the plane orthogonal to the rotary shaft of the rotor is overlapped at least partly with the projection area of the first protrusion structure on the plane orthogonal to the rotary shaft of the rotor.

### BACKGROUND OF THE INVENTION

1. Field of the Invention

The present invention relates to a color wheel unit used in a projection display device to project a color image on, for example, a screen by a time division system or a color sequential system.

2. Description of the Related Art

A projection display device is adapted to display a picture image in such a manner that a white light emitted from a light source is separated into three primary colors, specifically, red, green and blue color lights by a color wheel, then the red, green and blue color lights are modulated into red, green and blue image lights by an optical modulator, such as a liquid crystal panel and DMD (digital micro-mirror device), and the red, green and blue image lights are projected onto a screen or the like.

FIG. 4 is a schematic view of a conventional projection display device which includes: an illumination system composed of a lamp 1, a reflector mirror 2, a color wheel 3, a rod lens 4, and relay lenses 5 and 6; and an image formation system composed of a concave reflector lens 7, a specular reflection type light modulator (for example, DMD) 8, and a projection lens 9.

In the illumination system, a light emitted from the lamp 1, which is located at the first focal point of the reflector mirror 2, is collected at the second focal point of the reflector mirror 2 and subjected to time division color separation by the color wheel 3, and the separated lights from the color wheel 3 pass through the rod lens 4 and the relay lenses 5 and 6 and come to the image formation system. In the image formation system, the lights coming out from the relay lens 6 impinge on and are reflected at the concave reflector lens 7, then fall incident on and get reflected at the specular reflection type light modulator 8 so as to be modulated into respective image lights, and the respective image lights are projected onto a screen or the like by the projection lens 9.

The rod lens 4 is to uniform the distribution of the lights falling incident on the specular reflection type light modulator 8, the relay lenses 5 and 6 are to efficiently relay the lights from the rod lens 4 to the specular reflection type light modulator 8, and the concave lens 7 is to change the direction of the lights toward the specular reflection type light modulator 8 and also to efficiently converge the lights on the projection lens 9.

The color wheel 3 is structured such that a plurality of sector-shaped dielectric multilayer filters adapted to transmit respective lights having red, green and blue wavelengths are formed on a disk-like plate made of a light transmittable material, such as optical glass. The color wheel 3 is fixed to a motor 10 via a hub in a concentric manner, and thereby is caused to rotate with the rotation of the motor 10.

Thus, the color wheel 3 operates to color-separate sequentially the light from the lamp 1 while rotating rapidly, and this operation gives a problem that a high wind noise is generated due to the rapid rotation. In order to cope with the wind nose problem, conventionally, the color wheel 3, together with the motor 10, is housed in a color wheel case (not shown). The color wheel case functions also as a protective means which, when the color wheel 3 is broken, prevents its fragments from flying away, thus constituting an important measure for safety.

In a projection display device, a high pressure mercury lamp with high output is often used as the lamp 1 in order to produce an adequately bright projection image, which results in providing a problem that the temperature inside the display device becomes high due to the radiation heat from the lamp 1. Further, the color wheel 3 is also involved with a heat which is generated due to an absorption loss caused when light transmits or is reflected at color filters. Consequently, the temperature inside the aforementioned color wheel case is raised by the radiation heat from the lamp 1 and also by the heat due to the absorption loss of the color wheel 3, and so the reliability of the motor 10 may possibly be damaged.

In order to suppress the temperature rise inside a sealed color wheel case, a color wheel unit is disclosed which includes a color wheel case having radiation fins at its outer face (refer to, for example, Japanese Patent Application Laid-Open No. 2002-90886).

FIGS. 5 and 6 show the color wheel unit described in the aforementioned Japanese Patent Application Laid-Open No. 2002-90886. The color wheel unit shown in FIGS. 5 and 6 includes a color wheel 3, a motor 10, and a case composed of a lid section 11 and a body section 12. The lid section 11 has a light transmission hole 11. The motor 10 is fixed to the body section 12, and the color wheel 3 is housed inside the case (11+12) which is set up with the lid section 11 attached to the body section 12. Radiation fins 13 are formed integrally with the lid section 11, and heat transferred to the case (11+12) is efficiently radiated in the air.

Also, in order to suppress the projection display device from getting heated up, a color wheel assembly is disclosed in which a fan blade assembly having a plurality of blades is provided around a motor (refer to, for example, Japanese Patent Application Laid-Open No. 2006-23747).

FIG. 7 shows the color wheel assembly described in the aforementioned Japanese Patent Application Laid-Open No. 2006-23747. The color wheel assembly shown in FIG. 7 includes a color wheel 3, a motor 21, and a fan blade assembly 23. The fan blade assembly 23 includes a plurality of blades 25 formed at the circumference of the motor 21, and when the motor 21 is rotated, the fan blade assembly 23 is also rotated, whereby the air inside the device is caused to move, and the device is cooled down.

In the color wheel unit shown in FIGS. 5 and 6, the surface area of the case lid 11 is increased thereby enhancing the radiation performance, but there is still room left for further improvement in the performance of radiating the heat inside the case (11+12). Also, the color wheel assembly shown in FIG. 7 is effective in dissipating heat by causing airflow, but mere incorporation of such a color wheel assembly into the color wheel unit shown in FIGS. 5 and 6 does not necessarily result in achieving a sufficient effect in improving the radiation performance inside the case (11+12).

### SUMMARY OF THE INVENTION

The present invention has been made in light of the above problems, and it is an object of the present invention to provide a color wheel unit in which a temperature rise inside a color wheel case is effectively suppressed.

In order to achieve the object described above, according to an aspect of the present invention, there is provided a color wheel unit which includes: a color wheel including a plurality of color regions; a motor adapted to rotate the color wheel and including a rotor with a rotary shaft; and a case adapted to house the color wheel and the motor and including a heat radiating means disposed at the outer surface of the case. In the color wheel unit described above, a first protrusion structure extending radially outwardly is disposed at the outer circumferential surface of the rotor, and a second protrusion structure extending radially inwardly is disposed at the inner surface of the case, wherein the projection area of the second protrusion structure on the plane orthogonal to the rotary shaft of the rotor is overlapped at least partly with the projection area of the first protrusion structure on the plane orthogonal to the rotary shaft of the rotor.

Since the projection area of the second protrusion structure on the plane orthogonal to the rotary shaft of the rotor is overlapped at least partly with the projection area of the first protrusion structure on the plane orthogonal to the rotary shaft of the rotor while the motor rotates, the first and second protrusion structures are caused to closely oppose each other at least partly, whereby the heat transferred from the rotor to the first protrusion structure is adapted to travel from the first protrusion structure to the second protrusion structure (for example, by radiation and convection), thus the heat conductance from inside the case to the outer surface of the case is enhanced, and the heat generated inside the case can be efficiently dissipated outside from the heat radiating means provided at the outer surface of the case.

Also, when the first protrusion structure provided at the outer circumferential surface of the rotor revolves with the rotation of the motor, airflow is caused inside the case. Consequently, even if the case is hermetically closed, the heat generated inside the case can be dispersed by the airflow, and the color wheel unit is prevented from getting heated remarkably high at a certain limited area.

And, if the case is structured so as to allow air circulation between inside and outside the case, the heat generated inside the case can be let out with the airflow. With such a case structure, the first and second protrusion structures provided inside the case not only constitute heat transmission paths from the inside of the case to the outer surface of the case as described above but also function as radiation fins for dissipating the heat of the rotor and the heat of the case, respectively, thus increasing the heat radiation area of the color wheel unit and also effectively cooling the color wheel unit from inside the case.

In the aspect of the present invention, the first and second protrusion structures may each include a surface oriented slant with respect to the plane orthogonal to the rotary shaft of the rotor. As a result, the airflow generated by the revolving of the first protrusion structure includes an axial flow component thereby effectively dispersing the heat inside the case. Also, the above-described overlapping between the first and second protrusion structures is retained so as to maintain a sufficient thermal binding therebetween and to reduce wind noises.

In the aspect of the present invention, the case may include a first opening functioning as an air inlet for the airflow generated by the revolving of the first protrusion structure, and a second opening functioning as an air outlet for the airflow, whereby the aforementioned case structure to allow air circulation between inside and outside the case is realized, and a cooling effect is enhanced. Preferably, the first opening (for example, as an air inlet) is located close to the color wheel, and the second opening (for example, as an air outlet) is located close to the motor, whereby the airflow including an axial flow component can be effectively utilized, thus more efficiently cooling the inside of the case.

In the aspect of the present invention, the first and second protrusion structures may each include a plurality of blades. Consequently, the amount of the airflow generated inside the case increases, and the wind noises at the first and second protrusion structures can be reduced. The blades may be each configured so as to have a larger thickness at its middle portion than at its leading and trailing edges thus forming an airfoil profile, or to be curved between the leading and trailing edges thus forming another airfoil profile, or to form still another profile combining the aforementioned two profiles.

According to the present invention, in a color wheel unit provided with a case to house a color wheel and a motor, a temperature rise inside the case is effectively suppressed, which results in making the color wheel unit highly reliable.

### BRIEF DESCRIPTION OF THE DRAWINGS

FIG. 1 is a partly cross sectional side view of a color wheel unit according to one embodiment of the present invention;

FIG. 2 is a side view of a color wheel assembly incorporated in the color wheel unit of FIG. 1;

FIG. 3 is a rear view of the color wheel assembly seen when a color wheel case is cross-sectioned along line B-B in FIG. 1;

FIG. 4 is a schematic view of a conventional projection display device;

FIG. 5 is a perspective view of a conventional color wheel unit;

FIG. 6 is a partly cross sectional view of the conventional color wheel units of FIG. 5; and

FIG. 7 is a side view of a conventional color wheel assembly.

### DETAILED DESCRIPTION OF THE INVENTION

An exemplary embodiment of the present invention will be described with reference to the accompanying drawings.

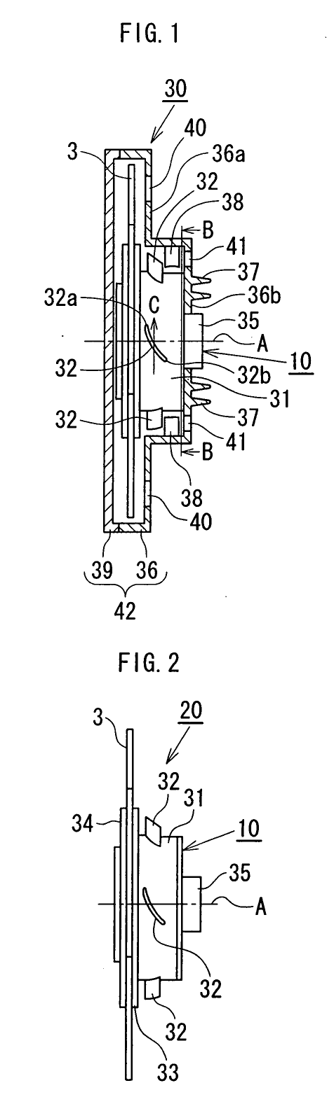

Referring to FIG. 1, a color wheel unit 30 includes a color wheel 3, a motor 10, and a case 42 to house the color wheel 3 and the motor 10. The color wheel 3 is composed of a plurality of sector-shaped color filter segments put together in a disk configuration. Each of the color filter segments is structured such that a dielectric multilayer film to transmit a light having a specific (red/green/blue) wavelength is formed on a sector-shaped substrate made of a light transmittable material such as optical glass.

Referring also to FIG. 2, the motor 10 is an outer rotor brushless DC motor principally including a stator core (not shown), and a rotor 31 having a rotor magnet opposing the outer circumference of the stator core, wherein a flange 33 is fixedly attached to a hub (not shown) which is fixed to a rotary shaft (not shown) of the rotor 31. The color filter segments constituting the color wheel 3 are fixedly attached to the motor 10 such that the color filter segments are adhesively fixed onto the flange 33 and then a support member 34 is placed on the color filter segments and engaged with the hub on the motor 10 so as to press the color filter segments toward the flange 33, whereby a color wheel assembly 20 is built up in which the color wheel 3 is fixedly coupled to the motor 10 so as to rotate with the rotation of the motor 10.

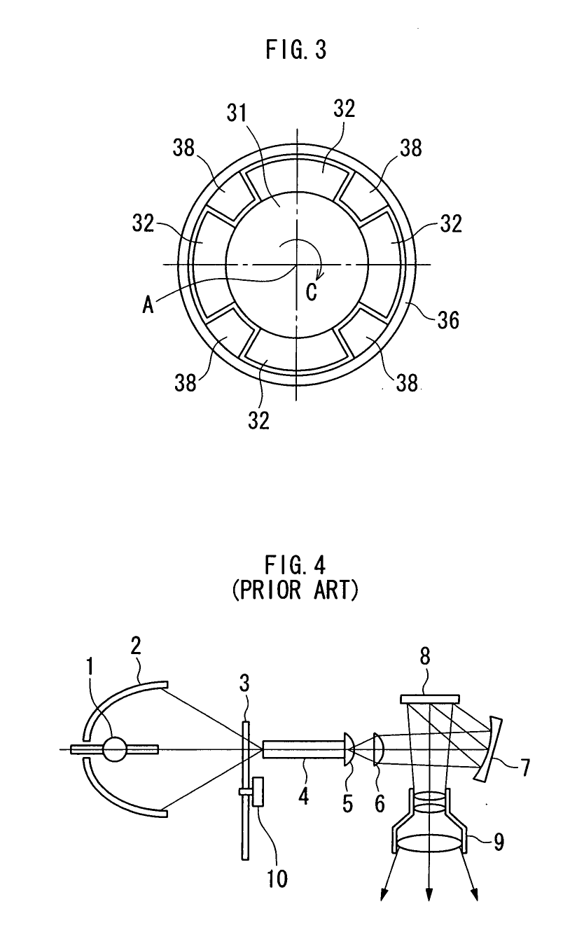

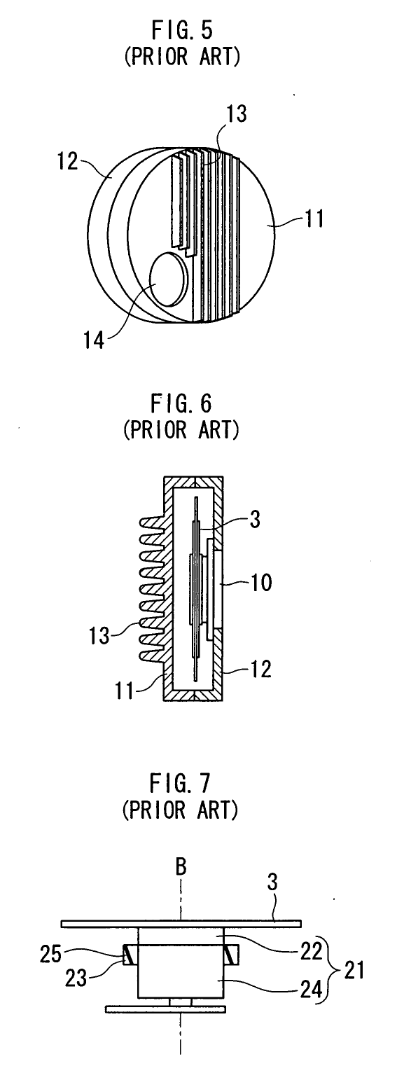

Referring additionally to FIG. 3, the motor 10 includes a first protrusion structure which is composed of four first blades 32 arranged equiangularly on the outer circumferential surface of the rotor 31 so as to extend radially outwardly. The first blades 32 are oriented to slant with respect to a plane orthogonal to the rotary shaft (its center is indicated by A in FIGS. 1 to 3) of the rotor 31.

The case 42 is composed of a base section 36 having a double cylindrical framework with major and minor cylinder portions and a lid section 39, and the color wheel unit 30 is built up such that the color wheel assembly 20 is fixed to the base section 36 with a boss 35 of the motor 10 engaging with a circular bottom wall 36b of the base section 36 and then the lid section 39 is attached to the base section 36.

On the case 42, radiation fins 37 are provided at the outer surface of the base section 36 (specifically, the circular bottom wall 36b in FIG. 1), and a plurality of openings 40 and 41 for allowing airflow are formed respectively at an annular rear wall 36a of the base section 36 opposing the color wheel 3 and at the circular bottom wall 36b of the base section 36.

The axial direction position and dimension of the first blades 32 disposed on the outer circumferential surface of the rotor 31 of the motor 10 are determined such that a certain clearance distance is provided from the first blades 32 to the inner surface of the circular bottom wall 36b of the base section 36 as shown in FIG. 1 when the color wheel assembly 20 is fixed to the base section 36 of the case 42. In an open space defined by the aforementioned clearance distance, a second protrusion structure is provided which is composed of four second blades 38 arranged equiangularly on the inner circumferential surface of the minor cylinder portion of the base section 36 so as to extend radially inwardly toward the outer circumferential surface of the rotor 31. The second blades 38 are oriented also to slant with respect to the plane orthogonal to the rotary shaft of the rotor 31.

Since the radial distal end (outermost portion) of the first blades 32 of the first protrusion structure provided at the outer circumferential surface of the rotor 31 is positioned farther from the shaft center A than the radial distal end (innermost portion) of the second blades 38 of the second protrusion structure provided at the inner circumferential surface of the minor cylinder portion of the base section 36 as shown in FIG. 3, when the first blades 32 revolve with the rotation of the rotor 31, a portion of each first blade 32 becomes located behind each second blade 38, whereby the projection area of the first blade 32 on the plane orthogonal to the rotary shaft of the rotor 31 becomes partly overlapped with the projection area of the second blade 38 on the aforementioned same plane.

In the present embodiment, the circumferential dimension of the second blade 38 is slightly smaller than the circumferential distance between adjacent two of the four first blades 32 disposed equiangularly, and therefore it can happen that the first blade 32 is positioned so as not to overlap with any portion of the second blade 38 (refer to FIG. 3). In the present embodiment, the color wheel assembly 20 is preferably fixedly attached to the base section 36 of the case 42 at a disposition position shown in FIG. 3.

In the present embodiment, the rotor 31 is made of a metallic material such as aluminum alloy, the first blades 32 are formed integrally with the rotor 31 by aluminum die-casting, or like methods, the base section 36 and the lid section 39 of the case 42 are made of a metallic material such as aluminum alloy, and the radiation fins 37 and the second blades 38 are formed integrally with the base section 36 by aluminum die-casting, or like methods.

Description will now be made on the operation of the color wheel unit 30 described above, and also the structure of the color wheel unit 30 will be further described in conjunction with the operation. While the following description will refer to the directions (or positions), left and right, with respect to the color wheel unit 30 in line with FIG. 1, the directions do not limit the actual disposition arrangement.

While the color wheel unit 30 operates, the first blades 32 of the first protrusion structure are caused to oppose portions of the second blades 38 of the second protrusion structure with respect to the direction along the rotary shaft of the rotor 31 except at the time of the disposition state shown in FIG. 3, whereby heat at the rotor 31 can be conducted to the case 42 via the first blades 32 and the second blades 38 thus enhancing the heat conduction performance from inside the case 42 to the outer surface of the case 42, and so the heat generated inside the case 42 can be efficiently released into the outside air from the radiation fins 37 provided on the outer surface of the case 42.

Referring again to FIG. 1, on the assumption that the rotor 31 rotates in a direction indicated by an arrow C (see FIGS. 1 and 3), the first blades 32 are each slanted relative to the rotation direction of the rotor 31 such that a leading edge 32a is positioned leftward and a trailing edge 32b is positioned rightward in the figure, that is to say, the first blades 32 are each oriented at a certain inclination angle with respect to the direction of an airflow moving from the leading edge 32a toward the trailing edge 32b, whereby a positive pressure is generated at the right side of each of the first blades 32 while a negative pressure is generated at the left side of each of the first blades 32, thereby causing an airflow including an axial flow component directed rightward in the figure (from the color wheel 3 toward the circular bottom wall 36b).

Accordingly, the plurality of openings 40 formed at the annular rear wall 36a of the base section 36 of the case 42 function mainly as air inlets into the inside of the case 42 while the plurality of openings 41 formed at the circular bottom wall 36b of the base section 36 function mainly as air outlets from the inside of the case 42, whereby air taken inside the case 42 through the openings 40 is caused to flow along the color wheel 3, then axially toward the circular bottom wall 36b, and to exit the case 42 through the openings 41. With the airflow caused as described above, heat generated inside the case 42 can be efficiently released outside.

In this connection, the first blades 32 of the first protrusion structure provided at the outer circumferential surface of the rotor 31 and the second blades 38 of the second protrusion structure provided at the inner surface of the case 42 not only constitute heat transmission paths from the inside of the case 42 to the outer surface of the case 42 as described above but also function as radiation fins for dissipating the heat of the rotor 31 and the heat of the case 42, respectively, thus increasing the heat radiation area of the color wheel unit 30 and also effectively cooling the color wheel unit 30 from inside the case 42.

Further, the first blades 32 are each configured such that the left side (negative pressure side) surface is curved convex, whereby the thickness at the leading edge 32a and the trailing edge 32b is smaller than the thickness at the middle portion, thus forming an airfoil profile. As a result, the amount of airflow in the axial direction is increased, and at the same time the separation flow of the airflow along the surface of the blade 32 is reduced lowering the wind noises.

The second blades 38 are also preferably configured to form an airfoil profile so that the wind noises attributable to the airflow running along the cascade of the second blades 38 can be reduced. The orientation of the second blades 38 is determined appropriately in consideration of the characteristics of the airflow generated by the rotor vanes and the stator vanes constituted respectively by the first blades 32 to move round with the rotation of the rotor 31 and the second blades 38 fixed to the case 42.

The present invention has been explained with reference to the exemplary embodiment but is not limited to the configuration described above. For example, the color wheel unit of the present invention may incorporate a color wheel assembly in which a color wheel fixedly attached to the rotary shaft of the rotor 31 is, as described in the explanation of the conventional projection display device shown in FIG. 4, structured such that a plurality of sector-shaped dielectric multilayer filters adapted to transmit respective lights having red, green and blue wavelengths are formed on a disk-like plate made of a light transmittable material, such as optical glass.

Also, the first blades 32 provided at the outer circumferential surface of the rotor 31 are formed integrally with the rotor 31 in the embodiment but may alternatively be produced discretely are fixedly attached to the rotor 31 by an appropriate fixing means or method, for example such that the first blades 32 are engaged in holes or slits formed in the rotor 31, or it may be arranged such that a mounting ring provided integrally with the first blades 32 is engagingly attached to the rotor 31. The alternative arrangements allow the first blades 32 to be made of a resin material, but a metallic material is preferable in view of radiation performance.

In the same way, the radiation fins 37 provided at the outer surface of the case 42 and the second blades 38 provided at the inner surface of the case 42 may be produced separately from the case 42 and fixedly attached to the case 42 by an appropriate means or method.

Further, the first and second blades 32 and 38 are not limited in number, size, shape, orientation angle and position to the configuration of the embodiment described with reference to FIGS. 1 to 3, but those design and layout particulars are to be appropriately determined according to the heat transference between the first blades 32 and the second blades 38, to the respective heat radiation performances of the first and second blades 32 and 38, and to the desired characteristic of the airflow generated by the revolving of the first blades 32. In consideration of the above conditions, the first blades 32 and/or the second blades 38 may be made of a thin sheet of a uniform thickness arranged in an appropriate profile, or made of a flat plate without curving.

In addition, the first blades 32 and/or the second blades 38 may be arranged in multiple arrays. For example, the first blades 32 may be arranged in two arrays with respect to the axial direction, and the second blades 38 may be arranged in one array between the two arrays of the first blades 32.

And, in the embodiment described above, the first and second blades 32 and 38 are configured and arranged to generate an airflow for which the openings 40 formed at the annular rear wall 36a of the case 42 function as air inlets while the openings 41 formed at the circular bottom wall 36b of the case 42 function as air outlets, but the first and second blades 32 and 38 may alternatively be configured and arranged to generate an airflow for which the openings 40 function as air outlets and the openings 41 function as air inlets.

1. A color wheel unit comprising:
a color wheel comprising a plurality of color regions;
a motor to rotate the color wheel, the motor comprising a rotor with a rotary shaft, wherein a first protrusion structure extending radially outwardly is disposed at an outer circumferential surface of the rotor; and
a case to house the color wheel and the motor, the case comprising a heat radiating means disposed at an outer surface of the case, wherein a second protrusion structure extending radially inwardly is disposed at an inner surface of the case, and a projection area of the second protrusion structure on a plane orthogonal to the rotary shaft of the rotor is overlapped at least partly with a projection area of the first protrusion structure on the plane orthogonal to the rotary shaft of the rotor.

2. A color wheel unit according to claim 1, wherein the first and second protrusion structures each comprise a surface oriented slant with respect to the plane orthogonal to the rotary shaft of the rotor.

3. A color wheel unit according to claim 1, wherein the case comprises a first opening functioning as an air inlet for an airflow generated by revolving of the first protrusion structure, and a second opening functioning as an air outlet for the airflow.

4. A color wheel unit according to claim 2, wherein the first and second protrusion structures each comprise a plurality of blades.

5. A color wheel unit according to claim 2, wherein the case comprises a first opening functioning as an air inlet for an airflow generated by revolving of the first protrusion structure, and a second opening functioning as an air outlet for the airflow.
